(19) United States
(12) Patent Application Publication
(10) Pub. No.: US 2026/0340050 A1
(43) Pub. Date: Oct. 29, 2026

(54) MANAGING GENERATIVE ARTIFICIAL INTELLIGENCE (AI) SESSIONS USING SUPPLEMENTED SESSION HISTORIES

(71) Applicant: Dell Products L.P., Round Rock, TX (US)

(72) Inventors: OFIR EZRIELEV, Be'er Sheva (IL); HANNA YEHUDA, Acton, MA (US); ANNE-MARIE MCREYNOLDS, San Jose, CA (US)

(21) Appl. No.: 19/191,612

(22) Filed: Apr. 28, 2025

(51) Int. Cl. G06F 16/9535; G06F 16/9538

(52) U.S. Cl. CPC G06F 16/9535; G06F 16/9538

(57) ABSTRACT

Methods and systems for providing computer-implemented services using generative AI models are disclosed. To do so, an updated session history for a generative AI session between a downstream consumer and a generative AI model may be obtained. The updated session history may be based on a request from the downstream consumer to remove information content from the generative AI session for a remaining duration of the generative AI session. If a portion of the updated session history is unintelligible due to insufficient contextual information for the portion being available in the updated session history, the insufficient contextual information may be supplemented to obtain a supplemented session history. The supplemented session history may include sufficient contextual information for the portion. Computer-implemented services may be provided to the downstream consumer using at least the supplemented session history.

### FIELD

Embodiments disclosed herein relate generally to providing computer-implemented services using generative artificial intelligence (AI) models. More particularly, embodiments disclosed herein relate to managing generative AI sessions using supplemented session histories.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show flow diagrams illustrating data flows in accordance with an embodiment.

FIGS. 2D-2G show an example graphical user interface (GUI) and an example generative AI session in accordance with an embodiment.

FIG. 3 shows a flow diagram illustrating a method for providing computer-implemented services using generative AI models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services using generative AI models. The generative AI models may include large language models (LLMs) that may generate outputs when provided with prompts. The outputs may be used, at least in part, to provide the computer-implemented services. For example, the outputs may be provided to a downstream consumer and the downstream consumer may use the outputs to make decisions.

The outputs may be provided to downstream consumers as part of generative AI sessions (e.g., chat sessions) with the downstream consumers. A generative AI session may include any exchange of prompts from a first entity (e.g., a downstream consumer) and outputs from a second entity (e.g., a generative AI model). For example, a chat session may be initiated by a downstream consumer (e.g., a client, a customer) via a graphical user interface (GUI). The customer may enter a prompt, which may be displayed in a chat window of the GUI. The prompt may be used as ingest for a generative AI model and the output generated by the generative AI model may be added to the chat window as a response from a chat agent (e.g., a virtual assistant). The downstream consumer may enter additional prompts during the chat session and all prompts and outputs may be recorded on the chat window during the chat session.

However, generative AI models may generate new outputs based on all components of the chat history (e.g., all prompts and outputs during the chat session). Therefore, if a downstream consumer mistakenly enters some information as a prompt or decides that a previously entered prompt is no longer desired to be used as part of the chat session (e.g., due to eliciting an unwanted response), the downstream consumer may have to begin a new chat session and/or may receive outputs during the chat session that do not meet needs of the downstream consumer (e.g., may be inaccurate, may be irrelevant).

To improve a user's (e.g., a downstream consumer's) experience and increase a likelihood of providing outputs that meet expectations of the downstream consumer, the user may request, via an interaction with the GUI, that information content be removed from a generative AI session history (e.g., a session history) of the chat session. The generative AI session history may include all prompts provided by the user during the chat session, all outputs provided to the user during the chat session, internal analysis information used by the generative AI model while generating outputs (e.g., information not provided to the user via the GUI), and/or other information related to the chat session. The generative AI model may be temporarily modified to obtain a temporarily updated generative AI model so that outputs generated by the temporarily updated generative AI model may be less influenced by the information content for a remaining duration of the chat session.

However, removal of information content from the session history may negatively impact other portions of the chat history (e.g., the other portions may rely on the removed information content). As the generative AI model may process the entire chat history when generating new outputs, the generative AI model may misinterpret the other portions of the chat history, which may reduce a likelihood that the new outputs meet the needs of the user.

For example, the session history may include the following text: “I can eat gluten but one of my friends cannot.” If the user elects to remove the information content of “I can eat gluten but” then the session history may retain the information content “one of my friends cannot.” The text “one of my friends cannot” may, therefore, rely on the prior portion of the sentence for comprehensibility. The retained information content may be misinterpreted by the generative AI model and/or by the user on a displayed record of the chat session.

To improve a likelihood of providing desired computer-implemented services (e.g., based on the chat session), chat session histories may be supplemented following removal of information content to reduce a likelihood that portions of the chat session histories may be misinterpreted (e.g., by generative AI models, by downstream consumers).

To do so, an updated session history may be obtained for a generative AI session between a downstream consumer and a generative AI model. The updated session history may be based on a request from the downstream consumer to remove information content from the generative AI session for a remaining duration of the generative AI session.

The updated session history may be processed to identify whether any portions of the updated session history rely on the information content that was removed. If, for example, a first portion of the portions relies on the information content, it may be concluded that the first portion is unintelligible (e.g., likely to be misinterpreted).

Supplementary contextual information may be obtained (e.g., may be generated by a second generative AI model, may be generated by a subject matter expert (SME), may be selected from the removed information content). The supplementary contextual information and the updated session history may be used to obtain a supplemented session history, the supplemented session history being less likely to be misinterpreted than the updated session history.

Computer-implemented services may be provided based on the supplemented session history. For example, the generative AI model may be temporarily modified based on the supplemented session history to obtain a second instance of the generative AI model. The second instance of the generative AI model may be less impacted by the information content than the generative AI model. An output may be generated by the second instance of the generative AI model based on the supplemented session history. The output may be added to the chat window and one or more actions may be performed based on the output.

Thus, embodiments disclosed herein may provide an improved method for providing computer-implemented services using generative AI models. To provide the computer-implemented services as desired by downstream consumers, information content may be removable from a current chat session thereby allowing the chat session to continue with less impact from the removed information content. Chat session histories may be supplemented so that retained portions of the chat session histories are unlikely to be misinterpreted following removal of the information content. Doing so may increase a likelihood that the chat session meets needs of a downstream consumer.

In an embodiment, a method for providing computer-implemented services using generative AI models is provided. The method may include: obtaining an updated session history for a generative AI session between a downstream consumer and a generative AI model of the generative AI models, the updated session history being based on a request from the downstream consumer to remove information content from the generative AI session for a remaining duration of the generative AI session; making an identification that a portion of the updated session history is unintelligible due to insufficient contextual information for the portion being available in the updated session history; based on the identification: supplementing, using the information content, the insufficient contextual information to obtain a supplemented session history, the supplemented session history comprising sufficient contextual information for the portion; providing computer-implemented services using at least the supplemented session history.

The updated session history may include: prompts provided by the downstream consumer; outputs generated by the generative AI model based on the prompts; and an updated memory for the generative AI model, the updated memory being based on the request and the updated memory comprising attention values assigned to portions of the prompts and portions of the outputs.

The attention values may reduce an impact of the information content on future outputs generated by the generative AI model.

Making the identification may include: processing the updated session history to identify whether any portions of the updated session history rely on the information content; and in an instance of the processing where at least one of the portions relies on the information content, concluding that the at least one of the portions is unintelligible.

The processing may include natural language processing to identify implicit and/or explicit referencing of the information content by portions of the updated session history.

The processing may include prompting a second generative AI model of the generative AI models to identify whether the any portions of the updated session history rely on the information content.

The at least one of the portions may be likely to be misinterpreted by the generative AI model.

The method may also include: displaying the updated session history to the downstream consumer via one or more graphical user interfaces (GUIs) so that the downstream consumer is likely to misinterpret the updated session history based on a representation of the information content in the displayed updated session history.

Supplementing the insufficient contextual information may include: obtaining, based on the insufficient contextual information and the information content, supplementary contextual information for the portion; and obtaining, using the updated session history and the supplementary contextual information, the supplemented session history.

Obtaining the supplementary contextual information may include: generating, using a second generative AI model of the generative AI models and based on the information content, one or more information elements that comprise the supplementary contextual information.

Obtaining the supplementary contextual information may include: identifying one or more information elements of the information content, the one or more information elements comprising the sufficient contextual information.

The method may also include: after supplementing the insufficient contextual information: displaying the supplemented session history to the downstream consumer via one or more graphical user interfaces (GUIs), the supplemented session history being unlikely to be misinterpreted by the downstream consumer due to a representation of the supplementary contextual information in the GUIs.

Providing the computer-implemented services may include: obtaining, using the supplemented session history and the generative AI model, an output.

The method may also include: prior to making the identification: obtaining, from the downstream consumer, the request; and performing, based on the request, an un-inferencing process to obtain the updated session history.

Performing the un-inferencing process may include at least one action selected from a list of actions consisting of: negating, based on the request and using the session history, embeddings corresponding to the information content to obtain the updated session history; adding, based on the request and using the session history, a negation layer to an input layer of the generative AI model to obtain a temporarily updated instance of the generative AI model, the temporarily updated instance of the generative AI model being stored as part of the updated session history; adding, based on the request and using the session history, the negation layer prior to an attention module of the generative AI model to obtain the temporarily updated instance of the generative AI model; and adding the negation layer to a hidden layer of the attention module to obtain the temporarily updated instance of the generative AI model.

The generative AI model may be a large language model (LLM).

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

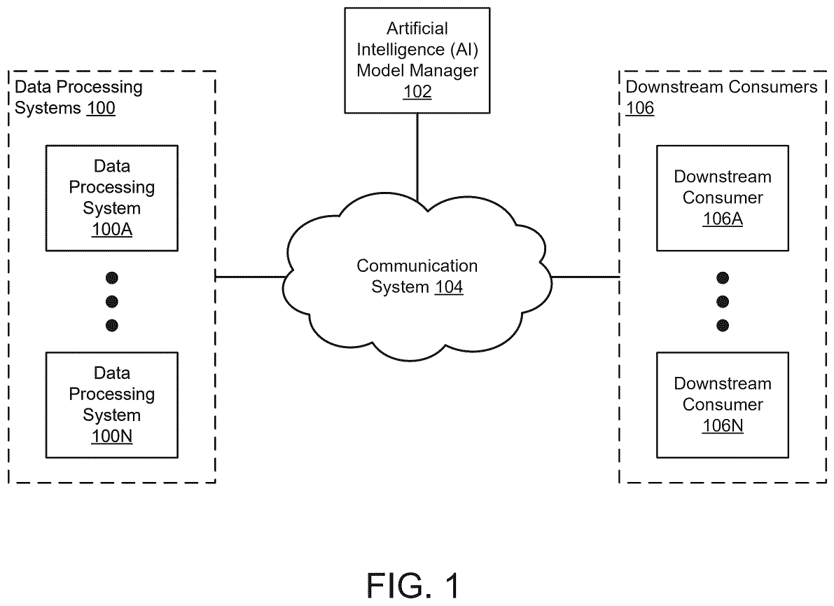

Turning to FIG. 1, a block diagram illustrating a system in accordance with an embodiment is shown. The system shown in FIG. 1 may provide for management of data processing systems that may provide, at least in part, computer-implemented services (e.g., to users of the system and/or devices operably connected to the system).

The computer-implemented services may include any type and quantity of computer-implemented services. The computer-implemented services may include, for example, database services, data processing services, electronic communication services, inference generation services, and/or any other services that may be provided using one or more computing devices. The computer-implemented services may be provided by, for example, data processing systems 100, AI model manager 102, downstream consumers 106, and/or any other type of devices (not shown in FIG. 1). Other types of computer-implemented services may be provided by the system shown in FIG. 1 without departing from embodiments disclosed herein.

The computer-implemented services may be provided, at least in part, using generative AI models and/or outputs obtained using the generative AI models. To do so, data processing systems 100 and/or AI model manager 102 may host any number of generative AI models.

To obtain the outputs, the generative AI models may be trained, using training data, to generate the outputs when provided with prompts (e.g., ingest data). The generative AI models may include large language models (LLMs) and, therefore, the outputs may include new instances of data created by the generative AI models based on learned associations from and/or an understanding of the training data. For example, the generative AI models may be trained using unstructured data, such as stories, essays, audio transcription, video description, and/or other types of human interpretable text, to generate outputs of the same. The outputs may be provided to downstream consumers 106 (e.g., client devices, data processing systems that manage computer systems and/or production systems) as part of providing the computer-implemented services.

The outputs may be provided to downstream consumers 106 as part of generative AI sessions (e.g., chat sessions) with downstream consumers 106. A chat session may include, for example, a real-time interaction between two entities (e.g., a downstream consumer and an AI agent) during which information is exchanged. The information may include prompts provided by the downstream consumer and outputs generated by a generative AI model. The prompts and the outputs may include any type of data modality (e.g., images, audio, video, text).

A chat session may be accessed by a downstream consumer (e.g., 106A) via one or more graphical user interfaces (GUIs) used as part of, for example, a customer support service, a data analysis service, a content creation service, and/or other services. Downstream consumer 106A may provide a prompt and the AI agent may provide an output that is responsive to the prompt. The AI agent may include a software program that manages, at least in part, operation of the generative AI model and that serves as a proxy for the generative AI model in a simulated conversation with the downstream consumer during the chat session. The generative AI model may use all previous prompts and all previously generated outputs to generate each additional output as part of the chat session.

However, downstream consumer 106A may provide information content via a prompt that is: (i) erroneous, (ii) irrelevant, and/or (iii) otherwise not desired to be used during a remainder of the chat session. In addition, a prompt may elicit an unwanted response (e.g., a generative AI model output that does not meet expectations of downstream consumer 106A). As the information content may impact the remainder of the chat session, outputs generated by the generative AI model during the chat session may no longer meet expectations of downstream consumer 106A (e.g., may include inaccurate and/or irrelevant information). In addition, downstream consumer 106A may need to end the chat session and begin a new chat session with the AI agent to remove an impact of the undesired information content thereby incurring a cost of time resources for downstream consumer 106A that may be undesirable.

In general, embodiments disclosed herein may provide methods, systems, and/or devices for updating a session history for the generative AI session for a duration of a chat session based on feedback from a downstream consumer to obtain an updated session history. The feedback may include a request for removal of information content from the generative AI session history (e.g., prompts provided by the downstream consumer during the chat session, outputs generated by the generative AI model based on the prompts, contextual data and/or internal analysis data used by the generative AI model, a memory (e.g., internal state) of instances of the generative AI model).

The session history may be displayed to the downstream consumer via one or more GUIs and the downstream consumer may interact with the one or more GUIs to select portions of the session history that are desired to be removed.

Obtaining the updated session history may include: (i) negating, based on the request, embeddings corresponding to the information content requested to be removed from the generative AI session history, (ii) adding, based on the request, a negation layer to an input layer of an instance of the generative AI model, (iii) adding, based on the request, a negation layer that feeds into an attention module of an instance of the generative AI model, (iv) adding, based on the request, a negation layer to a hidden layer of an attention module of an instance of the generative AI model, and/or (v) other methods.

A temporarily updated generative AI model (e.g., a modified instance of the generative AI model) may be obtained based on the updated session history and used to generate an output. The output may be added to a record of the generative AI session displayed to the downstream consumer via the one or more GUIs.

However, retained portions of the updated session history (e.g., information content that was not removed) may rely on the removed information content. Therefore, following removal of the information content, a portion of the updated session history may be unintelligible (e.g., likely to be misinterpreted by the generative AI model and/or the downstream consumer). Misinterpretation of portions of the updated session history may reduce a usefulness of outputs generated by the generative AI model to the downstream consumers.

To reduce a likelihood that portions of the updated session history are misinterpreted, the updated session history may be processed following removal of the information content to identify whether any portions of the updated session history rely on the information content.

For example, the session history may include the text: “large language model (LLM) X performs well on data Y but LLM Z does not.” The information content “large language model (LLM) X performs well on data Y but” may be removed from the session history to obtain the updated session history. Therefore, the updated session history may include the text “LLM Z does not,” which may be misinterpreted by a generated AI model and/or by a downstream consumer.

If one or more portions of the updated session history relies on the information content, the updated session history may be supplemented with supplementary contextual information to obtain a supplemented session history, the supplemented session history being less likely to be misinterpreted than the updated session history.

Continuing with the above example, supplemental contextual information may include “perform well on data Y,” and the supplemented session history may, therefore, include “LLM Z does not perform well on data Y.” The supplemented contextual information may be highlighted for display to the downstream consumer to focus an attention of the downstream consumer on the supplemented contextual information.

The supplemented session history may be used to provide computer-implemented services to downstream consumers. Providing the computer-implemented services may include obtaining, using an instance of the generative AI model updated based on the supplemented session history and the supplemented session history, an output. The output may be provided to the downstream consumer, used to make decisions, used to update a system, and/or may be used in other ways to provide desired computer-implemented services.

Thus, embodiments disclosed herein may improve processes of providing computer-implemented services to downstream consumers using generative AI models. By supplementing generative AI sessions that may include unintelligible information, a likelihood that the generative AI sessions meet needs of the downstream consumers may be increased.

To provide the above noted functionality, the system of FIG. 1 may include data processing systems 100, AI model manager 102, downstream consumers 106, and communication system 104. Each of these components is discussed below.

Data processing systems 100 may provide all, or a portion of, the computer-implemented services. Data processing systems 100 may include any number of data processing systems (e.g., 100A-100N) that may provide output generation services to downstream consumers 106. For example, a downstream consumer (e.g., 106A) may subscribe to output generation services provided by data processing system 100A and downstream consumer 106A may provide prompts (e.g., from clients, from owners of downstream consumer 106A, from employees of a company that owns downstream consumer 106A) to data processing system 100A as part of the subscribed services.

As part of providing the computer-implemented services, data processing systems 100 may: (i) obtain prompts for generative AI models (e.g., hosted and/or operated by data processing systems 100), (ii) feed the prompts into a generative AI model to obtain outputs, and (iii) provide the outputs to downstream consumers as part of providing computer-implemented services to the downstream consumers.

Data processing systems 100 may provide chat session services to downstream consumers 106. For example, one or more of data processing systems 100 may host AI agents that manage chat sessions with users (e.g., downstream consumers). A record of the chat sessions may be displayed, via the GUI, on a user's device (e.g., one or more of downstream consumers 106).

As part of providing the computer-implemented services, data processing systems 100 may also: (i) obtain, from downstream consumer 106A, a request to remove information content from a generative AI session history for a generative AI model, (ii) perform, based on the request, an un-inferencing process to obtain an updated session history for a generative AI session so that outputs generated as part of the generative AI session are less influenced by the information content, and/or (iii) identify whether any portions of the updated session history rely on the information content.

If any portions of the updated session history rely on the information content, data processing systems 100 may: (i) supplement, using the information content, the updated session history to obtain a supplemented session history, (ii) provide computer-implemented services using at least the supplemented session history, and/or (iii) perform other actions.

At the conclusion of the generative AI session, data processing systems 100 may discard temporary modifications to the generative AI model based on the supplemented session history (e.g., modifications to an internal state such as zero masks and/or negation layers may be removed) so that future chat sessions may not be impacted by the modifications.

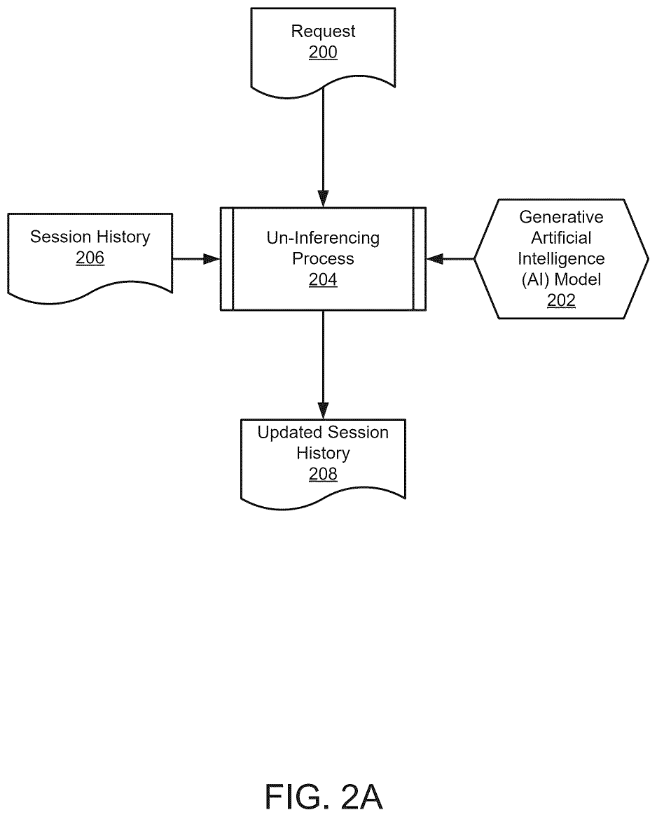

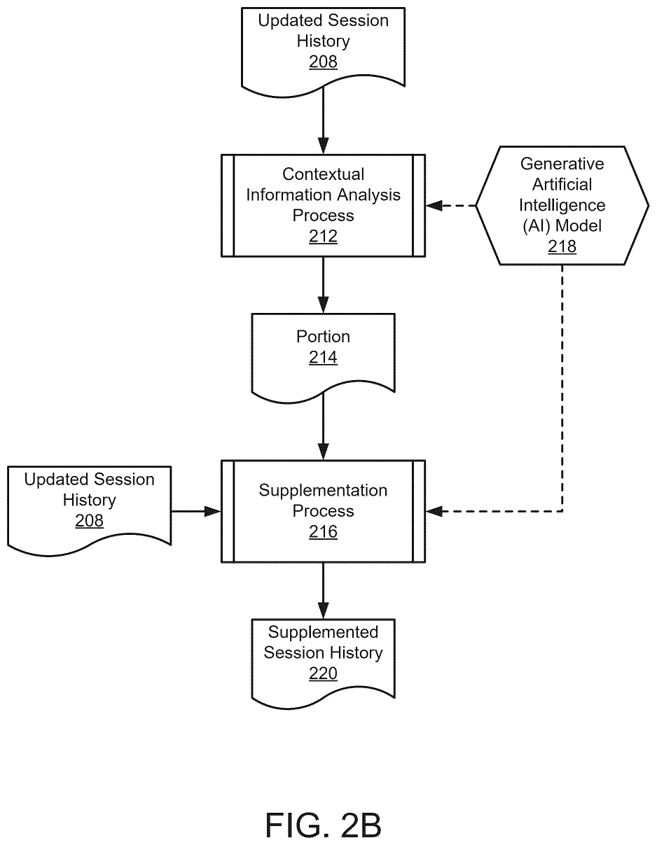

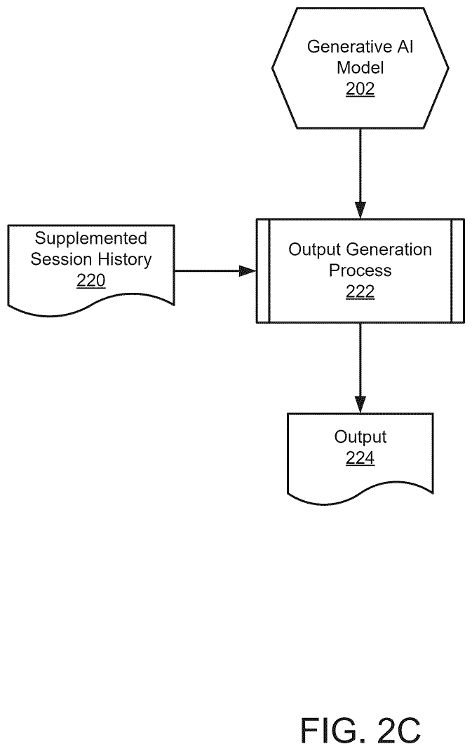

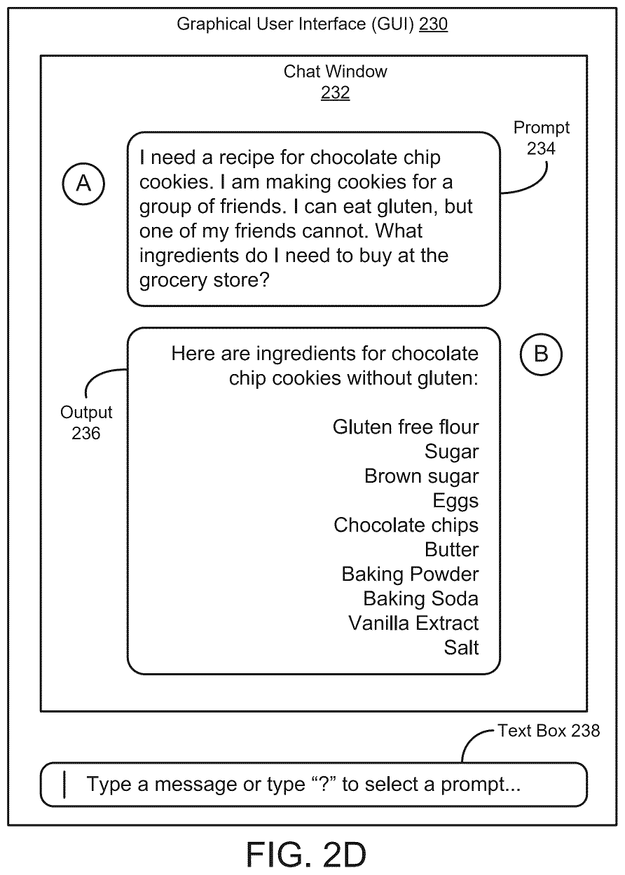

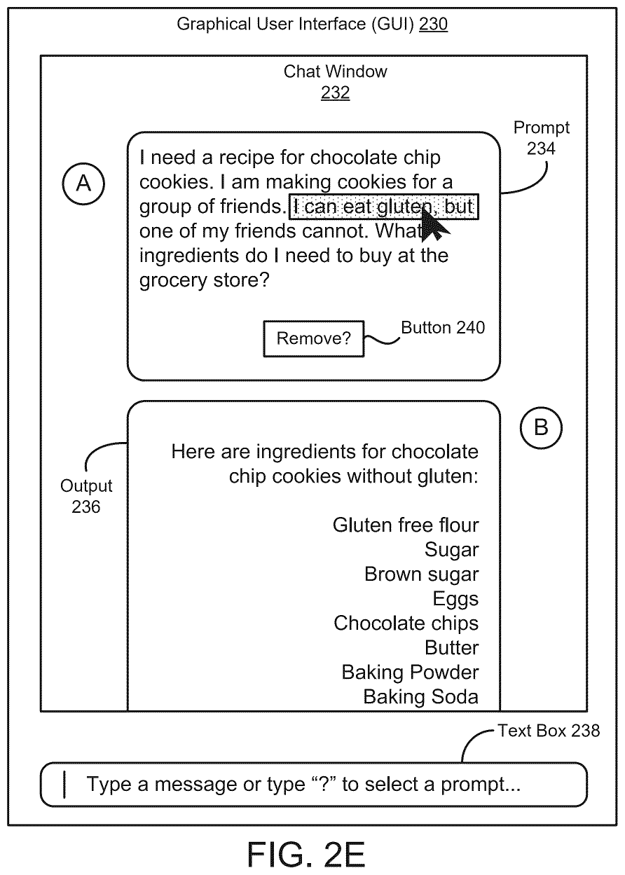

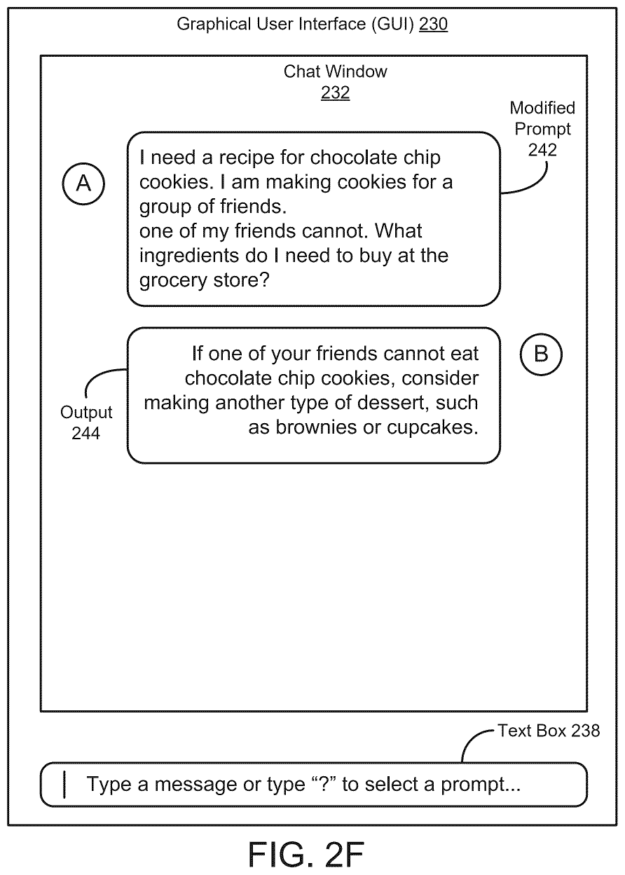

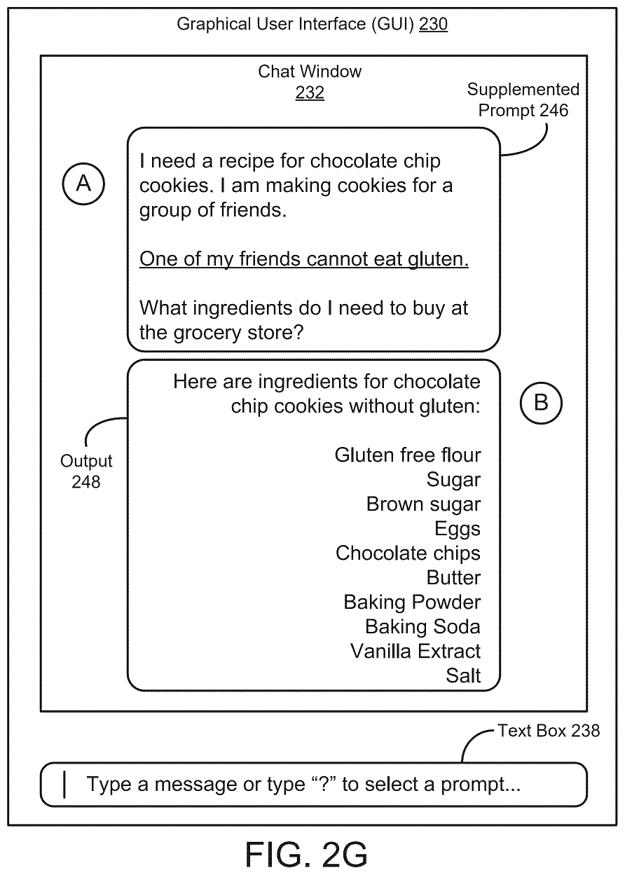

Refer to FIG. 2A for additional details regarding obtaining an updated session history. Refer to FIG. 2B for additional details regarding supplementing the updated session history to obtain a supplemented session history. Refer to FIG. 2C for additional details regarding providing computer-implemented services using at least the supplemented session history. Refer to FIGS. 2D-2G for an example of a chat session and an example of supplementing a session history for the chat session.

AI model manager 102 may manage any number of AI models. For example, AI model manager 102 may: (i) obtain training data for AI models, (ii) train any number of AI models to obtain trained AI models, (iii) deploy trained AI models to other entities (e.g., data processing systems 100), (iv) update and/or modify trained AI models (e.g., fine-tune trained AI models based on additional training and/or production data), and/or (v) provide other AI model management services.

For example, AI model manager 102 may cooperatively provide at least a portion of the computer-implemented services to data processing systems 100 by: (i) obtaining training data from downstream consumers 106, (ii) training one or more AI models (e.g., generative AI models) using at least the training data obtained from downstream consumers 106 to obtain one or more trained AI models, (iii) deploying the one or more trained AI models to data processing systems 100 for use in providing output generation services for downstream consumers 106, and/or (iv) performing other actions.

Downstream consumers 106 may provide and/or consume all, or a portion of, the computer-implemented services. Downstream consumers 106 may include any number of downstream consumers (e.g., 106A-106N) and may include, for example, businesses, individuals, and/or devices (e.g., data processing systems) that may obtain outputs and/or other information based on the outputs as part of receiving the computer-implemented services.

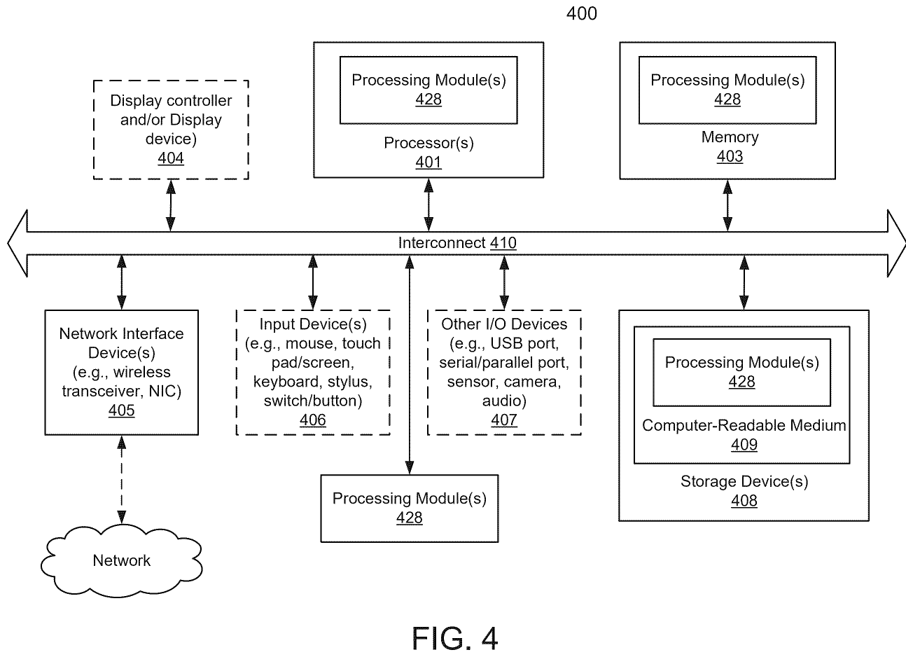

Any of (and/or components thereof) data processing systems 100, AI model manager 102, and downstream consumers 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

Communication system 104 may allow any of data processing systems 100, AI model manager 102, and downstream consumers 106 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to AI model manager 102 and downstream consumers 106 via the Internet. Data processing systems 100, AI model manager 102, downstream consumers 106, and/or communication system 104 may be adapted to perform one or more protocols for communicating via communication system 104.

While illustrated in FIG. 1 as including a limited number of specific components, a system in accordance with an embodiment may include fewer, additional, and/or different components than those illustrated therein.

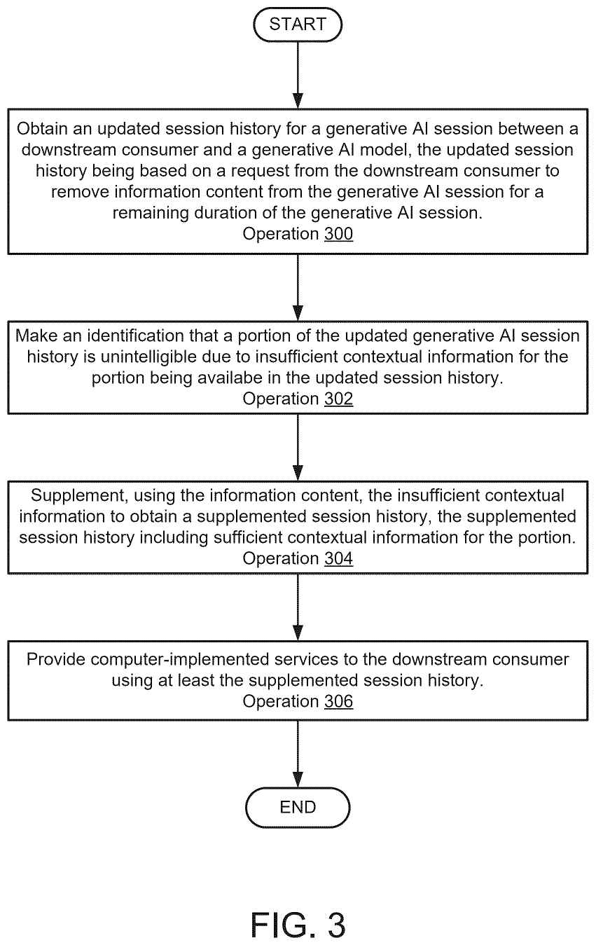

While providing their functionality, any of data processing systems 100, AI model manager 102, and/or downstream consumers 106 may provide all or a portion of the methods shown in FIGS. 2A-3.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 206, etc.) is used to represent data structures, a second set of shapes (e.g., 204, 212 etc.) is used to represent processes performed using and/or that generate data, and a third set of shapes (e.g., 202, 218) is used to represent generative AI models, and/or other types of models.

Turning to FIG. 2A, a first data flow diagram in accordance with an embodiment is shown. The first data flow diagram may illustrate data used in and data processing performed in obtaining an updated session history for a generative AI session based on a request from a downstream consumer.

Consider a scenario in which a downstream consumer initiates a generative AI session (e.g., with an AI agent hosted by one or more of data processing systems 100). During the chat session, the downstream consumer may provide prompts (not shown) and the AI agent may provide responses (e.g., outputs generated by a generative AI model based on the prompts). During the chat session, the downstream consumer may select information content to be removed from the generative AI session.

Request 200 may be obtained from the downstream consumer and may indicate information content that is desired to be removed from session history 206. Session history 206 may include: (i) any number of prompts provided by the downstream consumer, (ii) any number of outputs generated by generative AI model 202 based on the prompts, (iii) a memory (e.g., internal state) of generative AI model 202, and/or (iv) other contextual and/or analytic data related to operation of generative AI model 202 during the generative AI session. The memory of the generative AI model may include attention values and/or embeddings assigned to portions of the prompts and portions of the outputs during the generative AI session, information regarding an architecture (e.g., layers) of generative AI model 202, and/or other information.

Request 200 may be provided, by the downstream consumer, via an interaction with one or more graphical user interfaces (GUIs) (not shown, refer to FIGS. 2D-2G for an example GUI). The one or more GUIs may display, to the downstream consumer, a record of the chat session that includes prompts and outputs of session history 206. The one or more GUIs may also include functionality for the downstream consumer to select (e.g., using human interface devices such as a mouse and a keyboard) portions of session history 206 that are desired to be removed.

Selecting the portions of session history 206 may include: (i) highlighting a portion of session history 206, (ii) entering a command (e.g., to initiate a selection mode and/or to enter request 200), (iii) selecting a button on the GUI, and/or (iv) other actions.

Generative AI model 202 may be an LLM (e.g., a neural network inference model) trained to generate language, understand language, and/or otherwise process requests related to languages. Generative AI model 202 may have been previously trained using training data and any training process (e.g., a global optimization process using gradient descent), the training data indicating goals for outputs generated by generative AI model 202 (e.g., outputs). Parameters of generative AI model 202 may be selected using an optimization process (e.g., an objective function may be defined in terms of the training data and outputs generated by generative AI model 202, and a global optimization method such as gradient descent may be used to identify parameters that most faithfully reproduce the trends in the training data). Once the parameters of generative AI model 202 are set, then generative AI model 202 may be used to generate outputs (e.g., responses) based on input data (e.g., prompts). Generative AI model 202 may be trained using other methods without departing from embodiments disclosed herein.

To remove the portion of session history 206, un-inferencing process 204 may be performed. During un-inferencing process 204, modifications may be made to session history 206 based on request 200 and generative AI model 202 to obtain updated session history 208.

Making modifications to the session history 206 may include: (i) negating, based on request 200, embeddings corresponding to the portion of session history 206 that is desired to be removed to obtain updated session history 208 (e.g., identifying the embeddings in session history 206 and zero masking the embeddings so they are ignored when processed), (ii) removing (e.g., deleting) tokens that correspond to the portion of session history 206 from the memory of generative AI model 202, (iii) adding, based on request 200, a negation layer to an input layer of generative AI model 202 to obtain a temporarily updated instance of generative AI model 202 (e.g., stored as part of updated session history 208), (iv) adding, based on request 200, a negation layer that feeds into an attention module of the temporarily updated instance of generative AI model 202, and/or (v) adding, based on request 200, a negation layer to a hidden layer of the attention module.

The negation layers may be implemented so that the information content that is desired to be removed (e.g., sequences of tokens similar to and/or the same as tokens of the portion of session history 206 that is desired to be removed) pass through the negation layers at different points in the architecture of the temporarily modified instance of generative AI model 202 (e.g., prior to or after an input layer, prior to an attention module, in a hidden layer of the attention module). Therefore, when the same and/or similar tokens pass through the negation layers, operations may be performed to modify the values of the tokens.

Updated session history 208, therefore, may include: (i) the prompts, (ii) the outputs, and (iii) an updated memory for generative AI model 202. The updated memory may include information regarding modified embeddings (e.g., zero masks), information regarding modifications to attention values (e.g., un-inferencing weights that may modify a value and/or a sign of the attention values), architectures of negation layers, and/or other information based on request 200.

The temporarily modified instance of generative AI model 202 (not shown) may, therefore, include one or more of the above modifications thereby reducing an impact of the information content on future outputs generated during a remaining duration of the chat session. Refer to FIG. 2C for additional details regarding use of temporarily modified instances of generative AI models during chat sessions.

Turning to FIG. 2B, a second data flow diagram in accordance with an embodiment is shown. The second data flow diagram may illustrate data used in and data processing performed in supplementing an updated session history to obtain a supplemented session history, the supplemented session history being less likely to be misinterpreted (e.g., by a generative AI model, by a downstream consumer) than the updated session history.

To supplement the updated session history (e.g., updated session history 208), at least contextual information analysis process 212 and supplementation process 216 may be performed.

During contextual information analysis process 212, updated session history 208 may be processed to identify whether any portions of updated session history 208 rely on the information content (e.g., the information content that requested to be removed via request 200). If any portions of updated session history 208 rely on the information content, they may have insufficient contextual information and, consequently, may be unintelligible (e.g., likely to be misinterpreted).

Processing updated session history 208 may include: (i) performing natural language processing to identify implicit and/or explicit referencing of the information content by portions of updated session history 208, (ii) prompting a second generative AI model (e.g., generative AI model 218) to identify whether any portions of updated session history 208 rely on the information content, and/or (iii) other methods.

A portion may explicitly reference the information content by relying on the information content directly. For example, consider the sentence: “My friend traveled to Europe, but I have not been there.” The portion “I have not been there” may explicitly reference “Europe.”

A portion may implicitly reference the information content if the information content is useful in contextualizing the portion. For example, consider the prompt: “I need help deciding how to decorate for a friend's birthday party. Last year, we gave him balloons with the number twenty-nine on them. I want to do something extra special this year. Can you help me come up with some ideas?” The portion “I want to do something extra special this year” may implicitly reference on “twenty-nine” to indicate that this year the friend is turning thirty.

If, for example, the portion “Last year, we gave him balloons with” is requested to be removed, the generative AI model may misinterpret the prompt and may recommend ideas for decorations for a twenty-ninth birthday party or may otherwise provide outputs that are not tailored to a thirtieth birthday party.

The dotted line shown between generative AI model 218 and contextual information analysis process 212 is used to indicate that generative AI model 218 may or may not be used during contextual information analysis process 212. Generative AI model 218 may be similar to generative AI model 202 (e.g., may be another large language model (LLM)). Refer to FIG. 2F for an example of a portion of an updated session history that lacks sufficient contextual information.

Portion 214 may be obtained as a result of contextual information analysis process 212. Portion 214 may include one or more information elements of updated session history 208 that are considered unintelligible (e.g., likely to be misinterpreted by a generative AI model and/or a downstream consumer) due to portion 214 relying on the information content. Information elements may include any item, object, or entity mentioned in portion 214.

At least portion 214 and updated session history 208 may be used to perform supplementation process 216 to obtain supplemented session history 220. During supplementation process 216, supplemental contextual information may be obtained and updated session history 208 may be updated using the supplemental contextual information. By doing so, portion 214 may be less likely to be misinterpreted using supplemented session history 220 than using updated session history 208.

Updating updated session history 208 may include: (i) prompting a generative AI model (e.g., generative AI model 218) to generate the supplemental contextual information (e.g., a portion of text), (ii) selecting the supplemental contextual information from session history 206 (not shown) and adding the selected supplemental contextual information into updated session history 208 (e.g., by a subject matter expert, using an algorithm), and/or (iii) other methods.

Supplemented session history 220, therefore, may include: (i) the prompts, (ii) the outputs, (iii) the updated memory, and (iv) the supplemental contextual information. The supplemental contextual information may be displayed to the downstream consumer via one or more GUIs. Refer to FIG. 2G for an example GUI displaying supplemental contextual information to a downstream consumer.

Turning to FIG. 2C, a third data flow diagram in accordance with an embodiment is shown. The third data flow diagram may illustrate data used in and data processing performed in providing computer-implemented services to downstream consumers using at least supplemented session history 220 and generative AI model 202.

To provide the computer-implemented services, output generation process 222 may be performed. During output generation process 222, an instance of generative AI model 202 may be used to generate output 224. The instance of generative AI model 202 may process data using the updated memory included in supplemented session history 220 (e.g., a temporarily modified instance of generative AI model 202 may be obtained using generative AI model 202 and supplemented session history 220). Therefore, the temporarily updated instance of generative AI model 202 may utilize: (i) negated (e.g., masked) embeddings, (ii) negation layers (e.g., positioned prior to an input layer, positioned after an input layer, positioned prior to an attention module, positioned in a hidden layer of the attention module), (iii) previously generated attention values for portions of the outputs and the inputs (e.g., modified attention values), and/or (iv) other elements that may be used to reduce an impact of the information content on future outputs generated by generative AI model 202 for a remaining duration of the generative AI session.

During output generation process 222, at least supplemented session history 220 may be fed into the temporarily updated instance of generative AI model 202 to generate output 224 as output. Additional prompts provided by the downstream consumer (not shown) may also be ingested during output generation process 222. The instance of generative AI model 202 may include one or more negations (e.g., negation layers, masked embeddings) so that the information content has less of an impact on an internal state of the instance of generative AI model 202 and so that the information content may have a reduced impact on output 224.

At the conclusion of the chat session, the temporarily updated instance of generative AI model 202 may be discarded so that future chat sessions are not impacted by request 200. For example, any negation layers of supplemented session history 220 may only impact tokens of the input that were desired to be removed from the session history and, consequently, the negation layers may not impact new input data (e.g., the instance of generative AI model 202 may not require active reversion to generative AI model 202). If any zero masking or manual deletion of portions of memory of generative AI model 202 was performed, a memory wipe may be performed to remove the zero masks and/or other memory modifications thereby reverting attention values and available contextual information of generative AI model 202 to an internal state prior to the temporary update.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, by implementing the data flows shown in FIGS. 2A-2C, a system in accordance with embodiments disclosed herein may be used to obtain requests (e.g., feedback) for removal of information content from a session history of a chat session to obtain an updated session history. After un-inferencing based on the feedback, a supplementation process may be performed to reduce a likelihood that any portion of the session history is misinterpreted. Consequently, a reliability and/or usefulness of outputs may be increased for the downstream consumer.

Turning to FIG. 2D, an example graphical user interface (GUI) is shown. GUI 230 may display at least chat window 232 and text box 238. GUI 230 may be accessible by downstream consumers (e.g., via a website) and may include any number of pop-up interfaces, chat windows, buttons, graphics, and/or other elements through which information may be displayed to a viewer (e.g., a downstream consumer) and/or through which the viewer may interact. Other entities (e.g., an AI agent managing a chat service, a data processing system hosting the AI agent and/or any number of generative AI models) may populate GUI 230 with data intended to be displayed to the downstream consumer.

A downstream consumer may initiate a chat session with an AI agent (e.g., a computer program such as a chatbot) and chat window 232 and text box 238 may be displayed on GUI 230 to the downstream consumer for a duration of the chat session.

A customer may open chat window 232 and may enter prompt 234 into text box 238. Prompt 234 may include the following text: “I need a recipe for chocolate chip cookies. I am making cookies for a group of friends. I can eat gluten, but one of my friends cannot. What ingredients do I need to buy at the grocery store?” Prompt 234 is shown next to a circle with the letter “A” inside the circle to indicate input from a first entity (e.g., the downstream consumer).

Prompt 234 may be used as ingest for a generative AI model and output 236 may be obtained as output from the generative AI model. The generative AI model (e.g., and/or an AI agent participating in the chat session) may provide output 236 as a response to prompt 234. Output 236 may include the following text: “Here are ingredients for chocolate chip cookies without gluten: gluten free flour, sugar, brown sugar, eggs, chocolate chips, butter, baking powder, baking soda, vanilla extract, salt.” While described as a list including commas for readability, the list is shown in FIG. 2D without commas and with one ingredient per line. Output 236 is shown next to a circle with the letter “B” inside the circle to indicate input from a second entity (e.g., the AI agent).

The downstream consumer may continue the chat session by typing in additional prompts (not shown) to text box 238. In addition, other prompts and/or other outputs may have been added to chat window 232 prior to prompt 234. Text box 238, for example, may include a prompt instructing the downstream consumer to “type a message or type ”?“ to select a prompt . . . ” The downstream consumer may provide prompts and/or commands via other types of interactions with GUI 230 without departing from embodiments disclosed herein.

Therefore, the downstream consumer may enter a special character or command (e.g., “?” is shown as an example in FIG. 2D) to enable functionality to select a portion of prompt 234 and/or output 236 for removal from a session history of the chat session. Enabling selection information content for removal may be performed via other commands, other interactions, and/or other processes without departing from embodiments disclosed herein.

Turning to FIG. 2E, the downstream consumer may type in the command “?” in text box 238 to enable selection of a portion of prompt 234 (not shown). The downstream consumer may highlight, using a cursor on a display controlled by a human interface device such as a mouse, a portion of prompt 234.

For example, in FIG. 2E, the portion “I can eat gluten, but” has been highlighted on chat window 232 using a cursor. While shown with respect to highlighting a portion of prompt 234, portions of prompt 234 may be selected via other methods without departing from embodiments disclosed herein.

After selecting the text “I can eat gluten, but” button 240 may appear on chat window 232. If the downstream consumer selects button 240, the information content related to the highlighted portion of prompt 234 may be removed from the session history of the chat session.

The generative AI model used to generate output 236 may be temporarily modified so that future outputs generated by the temporarily updated generative AI model may be less influenced by the information content of “I can eat gluten, but” for a remaining duration of the chat session (e.g., some latent influence may remain).

Turning to FIG. 2F, the information content of “I can eat gluten, but” may be removed from chat window 232 to indicate that it has been removed from the session history. Therefore, modified prompt 242 may be shown on chat window 232 as including the text: “I need a recipe for chocolate chip cookies. I am making cookies for a group of friends. one of my friends cannot. What ingredients do I need to buy from the store?”

Output 236 may or may not be shown in chat window 232 (e.g., output 236 may be removed from chat window 232 as a result of removing a portion of prompt 234). In FIG. 2F, output 236 is not shown. The temporarily modified generative AI model instance may generate output 244 based on modified prompt 242.

Output 244 may include the text: “If one of your friends cannot eat chocolate chip cookies, consider making another type of dessert, such as brownies or cupcakes.” Therefore, the temporarily updated generative AI model instance may misinterpret modified prompt 242 based on removal of the information content of “I can eat gluten, but.”

Sufficient contextual information is not included for the text “one of my friends cannot” and, therefore, the text may be considered unintelligible.

Turning to FIG. 2G, the portion of modified prompt 242 that was concluded to be unintelligible may be supplemented to obtain supplemented prompt 246. Supplemented prompt 246 may include the text: “I need a recipe for chocolate chip cookies. I am making cookies for a group of friends. One of my friends cannot eat gluten. What ingredients do I need to buy at the grocery store?”

Output 248 may be generated by the temporarily modified generative AI model instance based on supplemented prompt 246. Output 248 may include same information content as output 236 shown in FIG. 2D and, therefore, the temporarily updated generative AI model instance may not have misinterpreted supplemented prompt 246. While shown in output 248 as including the same information content as output 236, it may be appreciated that some differences may occur (e.g., output 248 may differ from output 236) without misinterpreting supplemented prompt 246.

In FIG. 2G, the supplemented portion of supplemented prompt 246 may be placed on a separate line and underlined to focus an attention of the downstream consumer on the supplemented portion. The supplemented portion may be highlighted via other means on GUI 230 so that the downstream consumer knows which portions of supplemented prompt 246 are supplemented.

Thus, FIGS. 2D-2G show an example GUI and an example of a chat session between a downstream consumer and a backend system (e.g., an entity that hosts and/or operates generative AI models). It may be appreciated that the GUI may include other elements and information may be provided by the downstream consumer to the backend system via other methods without departing from embodiments disclosed herein.

As discussed above, the components of FIG. 1 may perform various methods to manage a data processing system. FIG. 3 illustrates methods that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing computer-implemented services using generative AI models in accordance with an embodiment is shown. The method may be performed, for example, by any of the components of the system of FIG. 1, and/or other components not shown therein.

At operation 300, an updated session history for a generative AI session between a downstream consumer and a generative AI model may be obtained (e.g., read from storage, received from another entity via a communication system, generated as part of the generative AI session). The updated session history may be based on a request from the downstream consumer to remove information content from the generative AI session for a remaining duration of the generative AI session.

Prior to obtaining the updated session history, the request may be obtained, and an un-inferencing process may be performed based on the request to obtain the updated session history. Obtaining the request may include: (i) receiving the request as part of a chat session with a downstream consumer, (ii) reading the request from storage, (iii) receiving the request from another entity via a communication system, and/or (iv) other methods. The downstream consumer may enter the request via a GUI and using any number of human interface devices operably connected to a device operated by the downstream consumer.

Performing the un-inferencing process may include at least one action selected from a list of actions consisting of: (i) negating, based on the request and using the session history, embeddings corresponding to the information content to obtain the updated session history, (ii) adding, based on the request and using the session history, a negation layer to an input layer of the generative AI model to obtain a temporarily updated instance of the generative AI model and storing the temporarily updated instance of the generative AI model as part of the updated session history, (iii) adding, based on the request and using the session history, the negation layer prior to an attention module of the temporarily updated instance of the generative AI model and storing the temporarily updated instance of the generative AI model as part of the updated session history, and (iv) adding the negation layer to a hidden layer of the attention module of the temporarily updated instance of the generative AI model and storing the temporarily updated instance of the generative AI model as part of the updated session history.

Negating the embeddings may include: (i) obtaining the embeddings corresponding to the information content (e.g., reading the embeddings from storage, obtaining the embeddings from another entity), (ii) zero masking the embeddings from (e.g., so that they are ignored when processed), and/or (iii) other methods.

Adding the negation layer to the generative AI model may include: (i) identifying elements (e.g., neurons) of an input layer of the generative AI model that consume the information content, (ii) performing an operation to modify a manner in which latent representations of the information content are processed prior to or following ingestion by the neurons of the input layer, and/or (iii) other methods. Performing the operation may include changing attention values of the input (e.g., multiplying the attention values by negative one). By doing so, the information content may be processed in a negated form (e.g., by the input layer, by a layer of neurons after the input layer).

Adding the negation layer (e.g., a layer that performs the modification of the information content) that feeds into the attention module may include methods similar to those described with respect to adding the negation layer to the input layer. However, the negation layer may be added to elements of the generative AI model that are located prior to an attention module of the generative AI model rather than in the input layer. Therefore, partially processed input data may pass through the negation layer prior to entering the attention module (e.g., attention layer) and/or after exiting the attention module.

Adding the negation layer to the hidden layer of the attention module may include methods similar to those described with respect to adding the negation layer to the input layer. However, the negation layer may be added within a hidden layer of the attention module rather than to the input layer. Therefore, partially processed input data may enter the attention module, pass through the negation layer at some point within the attention module, and may exit the attention module having passed through the negation layer.

At operation 302, an identification may be made that a portion of the updated generative AI session history is unintelligible due to insufficient contextual information for the portion being available in the updated session history. Making the identification may include processing the updated session history to identify whether any portions of the updated session history rely on the information content.

Processing the updated session history may include: (i) performing natural language processing to identify implicit and/or explicit referencing of the information content by portions of the updated session history, (ii) prompting a second generative AI model to identify whether the any portions of the updated session history rely on the information content, and/or (iii) other methods.

Performing natural language processing may include utilizing an algorithm (e.g., rules-based algorithm, statistical algorithm) and/or machine learning model (e.g., a deep learning model, a model with a transformer architecture) to process text from the updated session history, extract features from the text, and analyze the text. The algorithm and/or model may be trained to identify features in text that are likely to be misinterpreted due to a lack of sufficient contextual information for the features (e.g., based on any criteria for sufficient contextual information). Performing the natural language processing may also include providing at least a portion of the updated session history to another entity responsible for processing the text, extracting the features, and/or analyzing the features.

Prompting the second generative AI model may include: (i) obtaining the second generative AI model (e.g., training the second generative AI model, reading the second generative AI model from storage, receiving the second generative AI model from another entity), (ii) feeding a prompt into the second generative AI model, the prompt indicating that the second generative AI model is to process the updated session history to identify any portions that rely on the information content, and/or (iii) other methods.

If at least one of the portions relies on the information content, it may be concluded that the at least one of the portions is unintelligible. Concluding that the at least one of the portions is unintelligible may include: (i) labeling the portion as unintelligible, (ii) notifying another entity that the portion is unintelligible, (iii) generating an entry in an event log indicating that an unintelligible portion has been identified and that a supplementation process is to be performed, and/or (iv) other methods.

The updated session history may be displayed to the downstream consumer via one or more graphical user interfaces (GUIs) so that the downstream consumer is likely to misinterpret the updated session history based on a representation of the information content in the displayed updated session history.

Displaying the updated session history may include: (i) populating the one or more GUIs with portions of the updated session history in the form of a chat window (e.g., prompts and outputs may be displayed in chronological order), (ii) providing at least a portion of the updated session history to another entity responsible for populating the one or more GUIs, and/or (iii) other methods.

Operations 304, and 306 may be performed based on the identification made in operation 302.

At operation 304, the insufficient contextual information may be supplemented using the information content to obtain a supplemented session history. The supplemented session history may include sufficient contextual information for the portion. Supplementing the insufficient contextual information may include: (i) obtaining, based on the insufficient contextual information and the information content, supplementary contextual information for the portion, (ii) obtaining, using the updated session history and the supplementary contextual information, the supplemented session history, and/or (iii) other methods.

Obtaining the supplementary contextual information may include: (i) generating, using a second generative AI model of the generative AI models and based on the information content, one or more information elements that comprise the supplementary contextual information, (ii) identifying one or more information elements of the information content, the one or more information elements comprising the sufficient contextual information, and/or (iii) other methods.

Generating the one or more information elements may include: (i) obtaining the second generative AI model (e.g., training the second generative AI model, reading the second generative AI model from storage, receiving the second generative AI model from another entity), (ii) prompting, using a prompt the second generative AI model to generate an output, the prompt including instructions to generate language to reduce a likelihood that the unintelligible portions are misinterpreted (e.g., based on the removed information content and/or other information), (iii) providing the prompt, the removed information content, and/or the updated session history to another entity responsible for operating the second generative AI model, and/or (iv) other methods.

Identifying the one or more information elements may include: (i) selecting the one or more information elements from a portion of the updated session history that was removed, (ii) providing the updated session history and the removed information content to another entity responsible for identifying the one or more information elements, and/or (iii) other methods.

Obtaining the supplemented session history may include: (i) adding the one or more information elements to the updated session history in a manner that improves comprehensibility of the unintelligible portions of the updated session history, (ii) prompting a generative AI model to reconstruct, using the supplemental contextual information and the updated session history, the information content of the update session history in a manner that increases comprehensibility of the unintelligible portions, and/or (iii) other methods.

After supplementing the insufficient contextual information, the supplemented session history may be displayed to the downstream consumer via one or more graphical user interfaces (GUIs). The supplemented session history may be unlikely to be misinterpreted by the downstream consumer (e.g., when compared to the updated session history) due to a representation of the supplementary contextual information in the one or more GUIs.

Displaying the supplemented session history may include: (i) populating the one or more GUIs with portions of the supplemented session history in the form of a chat window (e.g., prompts and outputs may be displayed in chronological order including the supplemental contextual information), (ii) providing at least a portion of the supplemented session history to another entity responsible for populating the one or more GUIs, and/or (iii) other methods.

Displaying the supplemented session history may also include highlighting the supplemental contextual information on the one or more GUIs via any method of focusing an attention of the downstream consumer on the supplemental contextual information (e.g., via highlighting, via underlining, via different colors of text, via a pop-up window).

At operation 306, computer-implemented services may be provided to the downstream consumer using at least the supplemented session history. Providing the computer-implemented services may include: (i) obtaining, using the supplemented session history and the generative AI model, an output, (ii) making decisions based on at least the output, (iii) providing the output to another entity, (iv) selecting one or more actions based on the output and performing the one or more actions to update operation of a system, and/or (v) other methods.

Obtaining the output may include: (i) obtaining a temporarily modified instance of the generative AI model based on the supplemented session history (e.g., based on negation layers, based on modified attention values, based on modified embeddings), (ii) feeding at least the supplemented session history into the temporarily modified instance of the generative AI model (e.g., additional prompts provided by the downstream consumer may also be fed into the temporarily modified instance of the generative AI model if available), (iii) obtaining the output from an output layer of the temporarily modified instance of the generative AI model, and/or (iv) other methods.

The method may end following operation 306.

Thus, as illustrated above, embodiments disclosed herein may provide systems and methods usable to provide computer-implemented services using generative AI models. By supplementing portions of session histories that are missing sufficient contextual information, a likelihood of future outputs generated during the chat session meeting needs of the downstream consumer may be increased.

Any of the components illustrated in FIGS. 1-2G may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense. Please amend the claims as follows:

1. A method for providing computer-implemented services using generative artificial intelligence (AI) models, the method comprising:
obtaining an updated session history for a generative AI session between a downstream consumer and a generative AI model of the generative AI models, the updated session history being based on a request from the downstream consumer to remove information content from the generative AI session for a remaining duration of the generative AI session;
processing the updated session history to identify a portion of the updated session history that relies on the information content;
obtaining, based on the information content, supplementary contextual information for the portion;
supplementing, the updated session history with the supplemental contextual information to obtain a supplemented session history; and
providing computer-implemented services to the downstream consumer using at least the supplemented session history.

2. The method of claim 1, wherein the updated session history comprises:
prompts provided by the downstream consumer;
outputs generated by the generative AI model based on the prompts; and
an updated memory for the generative AI model, the updated memory being based on the request and the updated memory comprising attention values assigned to portions of the prompts and portions of the outputs.

3. The method of claim 2, wherein the attention values reduce an impact of the information content on future outputs generated by the generative AI model.

4. (canceled)

5. The method of claim 1, wherein the processing comprises performing natural language processing to identify implicit and/or explicit referencing of the information content by the portion of the updated session history.

6. The method of claim 1, wherein the processing comprises prompting a second generative AI model of the generative AI models to identify whether the portion of the updated session history relies on the information content.

7. (canceled)

8. The method of claim 1, further comprising:
displaying the updated session history to the downstream consumer via one or more graphical user interfaces (GUIs), the displayed updated session history comprising a representation of the information content.

9. (canceled)

10. The method of claim 1, wherein obtaining the supplementary contextual information comprises:
generating, using a second generative AI model of the generative AI models and based on the information content, one or more information elements that comprise the supplementary contextual information.

11. The method of claim 1, wherein obtaining the supplementary contextual information comprises:
identifying one or more information elements of the information content, the one or more information elements comprising the supplementary contextual information.

12. The method of claim 1, further comprising:
displaying the supplemented session history to the downstream consumer via one or more graphical user interfaces (GUIs), the displayed supplemented session history comprising a representation of the supplementary contextual information.

13. The method of claim 12, wherein the representation of the supplementary contextual information in the GUIs may be highlighted to focus an attention of the downstream consumer on the supplementary contextual information.

14. The method of claim 1, wherein providing the computer-implemented services comprises:
obtaining, using the supplemented session history and the generative AI model, an output.

15. The method of claim 1, further comprising:
prior to obtaining the updated session history:
obtaining, from the downstream consumer, the request; and
performing, based on the request, an un-inferencing process to obtain the updated session history.

16. The method of claim 15, wherein performing the un-inferencing process comprises at least one action selected from a list of actions consisting of:
negating, based on the request and using the session history, embeddings corresponding to the information content to obtain the updated session history;
adding, based on the request and using the session history, a negation layer to an input layer of the generative AI model to obtain a temporarily updated instance of the generative AI model, the temporarily updated instance of the generative AI model being stored as part of the updated session history;
adding, based on the request and using the session history, the negation layer prior to an attention module of the generative AI model to obtain the temporarily updated instance of the generative AI model; and
adding the negation layer to a hidden layer of the attention module to obtain the temporarily updated instance of the generative AI model.

17. The method of claim 1, wherein the generative AI model is a large language model (LLM).

18. A non-transitory machine-readable medium having instructions stored therein, which when executed by a processor, cause the processor to perform operations for providing computer-implemented services using generative artificial intelligence (AI) models, the operations comprising:
obtaining an updated session history for a generative AI session between a downstream consumer and a generative AI model of the generative AI models, the updated session history being based on a request from the downstream consumer to remove information content from the generative AI session for a remaining duration of the generative AI session;
processing the updated session history to identify a portion of the updated session history that relies on the information content;
obtaining, based on the information content, supplementary contextual information for the portion;
supplementing, the updated session history with the supplemental contextual information to obtain a supplemented session history; and
providing computer-implemented services to the downstream consumer using at least the supplemented session history.

19. The non-transitory machine-readable medium of claim 18, wherein the updated session history comprises:
prompts provided by the downstream consumer;
outputs generated by the generative AI model based on the prompts; and
an updated memory for the generative AI model, the updated memory being based on the request and the updated memory comprising attention values assigned to portions of the prompts and portions of the outputs.

20. A data processing system, comprising:
a processor; and
a memory coupled to the processor to store instructions, which when executed by the processor, cause the processor to perform operations for providing computer-implemented services using generative artificial intelligence (AI) models, the operations comprising:
obtaining an updated session history for a generative AI session between a downstream consumer and a generative AI model of the generative AI models, the updated session history being based on a request from the downstream consumer to remove information content from the generative AI session for a remaining duration of the generative AI session;
processing the updated session history to identify a portion of the updated session history that relies on the information content;
obtaining, based on the information content, supplementary contextual information for the portion;
supplementing, the updated session history with the supplemental contextual information to obtain a supplemented session history; and
providing computer-implemented services to the downstream consumer using at least the supplemented session history.

21. The data processing system of claim 20, wherein the updated session history comprises:
prompts provided by the downstream consumer;
outputs generated by the generative AI model based on the prompts; and
an updated memory for the generative AI model, the updated memory being based on the request and the updated memory comprising attention values assigned to portions of the prompts and portions of the outputs.

22. The data processing system of claim 21, wherein the attention values reduce an impact of the information content on future outputs generated by the generative AI model.

23. The data processing system of claim 20, wherein the processing comprises performing natural language processing to identify implicit and/or explicit referencing of the information content by the portion of the updated session history.
